(19) United States
(12) Patent Application Publication
(10) Pub. No.: US 2024/0061078 A1
(43) Pub. Date: Feb. 22, 2024

(54) METHOD FOR CALIBRATING AT LEAST ONE SIGNAL AND/OR SYSTEM PARAMETER OF A WAVE-BASED MEASURING SYSTEM

(71) Applicant: Symeo GmbH, Neubiberg (DE)

(72) Inventors: Peter Gulden, Erding (DE); Martin Vossiek, Fürth (DE); Johanna Geiß, Erlangen (DE); Erik Sippel, Nürnberg (DE)

(21) Appl. No.: 18/268,092

(22) PCT Filed: Dec. 2, 2021
(86) PCT No.: PCT/EP2021/083919

§ 371 Date: Jun. 16, 2023

(30) Foreign Application Priority Data
Dec. 18, 2020 (DE) 10-2020 134 284.5

(51) Int. Cl. G01S 7/40; G01S 13/931

(52) U.S. Cl. CPC G01S 7/4082; G01S 13/931

(57) ABSTRACT

The disclosure relates to a method for calibrating at least one signal and/or system parameter of a wave-based measurement system, in particular radar measurement system. At least one receiving unit for receiving signals and an object scene assume several spatial positions relative to each other assume, wherein a relative positioning of the several positions to each other is known or determined, and at these several positions the signals are coherently detected by the at least one receiving unit, whereby a set of several coherent measurement signals is formed.

### FIELD OF THE DISCLOSURE

The disclosure relates to a method for calibrating at least one signal and/or system parameter of a wave-based measurement system, in particular radar measurement system, a calibration system, a wave-based measurement system, preferably radar measurement system, an arrangement comprising an object scene as well as a calibration system, as well as a vehicle.

### BACKGROUND

Methods for calibrating parameters in wave-based measurement systems, in particular radar measurement systems, are known in principle. In this context, (arbitrary) parameters of signals (transmitted signals) and/or components of the respective measurement system that have an influence on the measurement result or the measurement properties of the measurement system can be calibrated.

Common calibration methods are based on measurements which in turn are based on a controlled and usually previously known target scene in the far field of the wave-based measurement system (sensor system), i.e. for example on a measurement of targets which are located at known angles in the far field of the measurement system to be calibrated. Furthermore, approaches are known that exploit information to the effect that the target scene is a sparsely occupied target scene. Thereby, the searched parameter and at the same time a target distribution can be estimated.

One state of the art for calibrating a coupling matrix (as a parameter to be calibrated) is based on reference measurements to targets (for example triple mirrors) at known angles located in the far field of a radar, as described for example in C. M. Schmid, C. Pfeffer, R. Feger, and A. Stelzer, “An FMCW MIMO radar calibration and mutual coupling compensation approach” published in 2013 at the European Radar Conference.

However, several problems can arise here. First, a far-field approximation must be guaranteed or be possible, which requires targets at a comparatively large distance, especially for large antenna apertures (where the far-field limit is to be considered at 2*L²/λ, with antenna aperture L and wavelength λ). In addition, the occurrence of comparatively strong multipaths during calibration must be prevented, which requires a correspondingly large reflection-free measurement environment (measurement chamber). This is found to be comparatively impractical (and indeed for many applications). In addition, an unknown phase and amplitude can occur with each reference target, so that the individual reference measurements cannot be processed coherently. For a calibration in the near-field, the positions of the reference targets relative to the radar would need to be known to within a fraction of a wavelength to determine a correct phase relationship between the antennas. This is seen as being considered as not (or at least difficult) viable.

Based on sparsity or compressed sensing or compressive sensing, approaches exist for simultaneous calibration of different parameters and angle estimation or estimation of a sparse (sparse) scene (object scene), see for example Ç. Bilen, G. Puy, R. Gribonval, and L. Daudet, “Convex Optimization Approaches for Blind Sensor Calibration Using Sparsity”, IEEE Trans. Signal Process. vol. 62, no. 18, pp. 4847-4856, September 2014, doi: 10.1109/TSP.2014.2342651 and A. Elbir and E. Tuncer, “2-D DOA and mutual coupling coefficient estimation for arbitrary array structures with single and multiple snapshot”, Digit. Signal Process. vol. 54, April 2016, doi: 10.1016/j.dsp.2016.03.011. This means that no known angles or target positions need to be given. This is usually proposed as a so-called online calibration, which is intended to enable an angle estimate to be made in the measurement situation even with an uncalibrated system. Only one measurement at a time is used to estimate the calibration parameters. This means that only little information is available. With this (theoretical) approach, a comparatively good calibration is hardly possible under realistic conditions because the information content is insufficient. Furthermore, in this context one usually assumes a target distribution that is only described by angles. This reduces the complexity, but (again) requires multipath-poor far-field measurements.

### SUMMARY OF THE DISCLOSURE

In particular, it is an object to propose a method for calibrating a wave-based measurement system (in particular radar measurement system), in which at least one signal and/or system parameter can be calibrated with comparatively little effort and yet comparatively precisely. Furthermore, it is the object to propose a corresponding calibration system, a corresponding wave-based measurement system, a corresponding arrangement comprising an object scene as well as a calibration system as well as a corresponding vehicle.

This object is solved in particular by the features of claim 1.

In particular, the object is solved by a method for calibrating at least one parameter to be calibrated (in particular a signal and/or system parameter) of a wave-based measurement system, in particular a radar measurement system, which comprises at least one receiving unit for receiving signals of a wave field, in particular radar signals, which preferably emanate from a sparsely occupied object scene (wherein, at least in the case of radar signals, it can be assumed in principle that the respective object scene is sparsely occupied), wherein the at least one receiving unit and the object scene assume several spatial positions relative to each other (at different points in time), wherein a relative positioning of the several positions relative to each other is known or determined (and thus becomes known), and at these several positions the signals are coherently detected by the at least one receiving unit (sensor) (and thus a synthetic aperture is formed), wherein a set of several coherent measurement signals is formed, wherein a calibration of at least one signal and/or system parameter is performed based on the at least one set of coherent measurement signals.

A key idea of the disclosure is to record measurement values at several positions (wherein the positioning of the several positions relative to each other is known or determined in advance). In particular, with or after a coherent processing of these measurement values, the resulting total aperture can also be referred to as synthetic aperture or inverse synthetic aperture. In principle, unless otherwise indicated, the term “synthetic aperture” shall include a non-inverse and/or inverse synthetic aperture. In this sense, these measurement values are then preferably (coherently) processed and provide information for a (full) calibration. Thereby, in particular, information is exploited to the effect that the object scene is a sparsely occupied target scene (or, in the specific case, a radar object scene that can be assumed to be sparse). In this respect, the disclosure is also based in particular on the assumption or prerequisite that the (respective) object scene is sparsely occupied.

By a sparsely occupied object scene is preferably meant an object scene that has less than 100 objects (separable by the measurement system) (or at least less than 100 dominant objects in the sense that strongly reflecting objects are supposed to be decisive for the sparseness, whereby, if necessary, further weakly scattering objects may be present as long as there are few dominant scatterers or objects).

In principle, the objects can be predetermined (known from the outset) objects, such as reference objects (e.g. metal elements, such as metal spheres), or basically unknown objects (such as objects or structures measurable by the measurement system of an environment of a possibly moving vehicle).

Under a signal and/or system parameter is to be understood in particular a parameter of a signal (in particular at least one signal transmitted by at least one transmitter of the measurement system) and/or a parameter of at least one component of the measurement system (if applicable absolute and/or in relation to another component, such as for example a distance and/or an orientation), which have an influence on the measurement result or the measurement properties of the measurement system.

The wave-based measurement system may be configured to work with electromagnetic, optical and/or acoustic waves. Particularly preferably, it is a radar measurement system, i.e. a measurement system that operates with radar waves. Such a measurement system may also be referred to as radar for short. The receiving unit can be formed by an antenna or comprise one or more antennas. In principle, however, the receiving unit can be provided with at least one device of any kind that enables reception of the respective waves (e.g. antenna in the case of electromagnetic waves; photodetectors or electro-optical mixers in the case of optical waves; sound transducers or microphones in the case of acoustic waves).

Signals can be transmitted by the measurement system, if necessary, and reflected at a sparsely occupied (but otherwise generally largely arbitrary) object scene (target scene) and received again by the measurement system. For example, in a classic radar scenario, a sparsely occupied object scene (or thinned out, sparsely occupied or sparse object scene) can be assumed by default, for example, in the sense described in D. L. Donoho, “Compressed sensing”, IEEE Trans. Inf. Theory, vol. 52, no. 4, pp. 1289-1306, April 2006, doi: 10.1109/TIT.2006.871582.

Overall, by the disclosed method a comparatively precise calibration of at least one signal and/or system parameter is enabled, and that with comparatively simple means (in terms of required hardware and/or software components and/or a required computing power). In particular, by the utilised synthetic aperture an information content of measurement data (e.g. measurement data vector or measurement matrix) is significantly increased compared to a single measurement. For example, a measurement process (e.g. described by a measurement matrix) can now be dependent also on the measurement position, although this can be assumed to be known, in addition to the parameter to be calibrated.

In particular, it is thus proposed to extend a (online) calibration based on compressed sensing to a preferably complete or more comprehensive calibration in that several measurements are taken of a sparsely occupied object scene at different positions and processed coherently, i.e. a synthetic aperture is build up.

The (respective) receiving unit preferably comprises at least one receiver (in particular at least one receiving antenna). The (respective) receiving unit may have at least one (or exactly one) transmitter (in particular a transmitting antenna) (i.e. optionally be designed as a transmitting and receiving unit). The (respective) receiver or the (respective) receiving antenna can also optionally (simultaneously) have a transmitting function (i.e. be designed as a combined transmitting-receiving or transmitting-receiving antenna).

The receiving unit may possibly have several receivers (for example, at least two or at least four or at least eight and/or at most 100). Furthermore, the receiving unit may possibly also comprise several transmitters (possibly at least two or at least four or at least eight and/or at most 100).

For example, the receiving unit (or transmitting-receiving unit) may be a TRX module.

The receiving unit can optionally also be equipped without a transmitter.

Optionally, in addition to the (at least one) receiving unit, at least one transmitting unit for transmitting the respective waves may also be present and/or the object scene may have at least one transmitter.

In particularly preferred embodiments, the measurement signals and/or signals derived from the measurement signals, for example Fourier-transformed signals and/or parameters derived from the measurement signals, are compared with hypothetical comparison signals or comparison parameters dependent on at least one parameter to be calibrated and/or a hypothetical target distribution. Preferably, during this comparison, a solution for the parameter (to be calibrated) is searched for and, in particular, determined in which a corresponding hypothetical target distribution is comparatively sparsely occupied, in particular as sparsely as possible.

Preferably, the sparseness is utilized as one of (possibly several) optimisation criteria, in particular such that a solution with a higher sparseness (i.e. in particular fewer targets and/or a lower sum of target amplitudes) is preferred (in the context of the optimisation) to a solution with a lower sparseness (i.e. in particular more targets or a higher sum of target amplitudes), further preferably a solution with maximum sparseness is preferred (and in particular selected) among several hypothetical solutions.

Under a sparseness in particular the number of detected (active and/or passive, i.e. in particular reflecting) wave field sources (whereby here a pure reflector is preferably also to be understood as a wave field source) is to be understood (or the number of dominant wave field sources, such that for the sparseness strongly radiating sources are to be decisive, whereby if necessary further weakly radiating sources can be present). Thus, for example, if five wave field sources are detected in a first hypothetical solution and 10 wave field sources are detected in a second solution, the first solution shall be selected as the preferred solution within the method (but possibly depending on further optimisation criteria). Sparse solutions can be achieved, for example, by minimising the l0 norm ∥\vec{x}∥₀ of a target vector, which determines the number of pixels that are not equal to zero, or by minimising the l1 norm ∥\vec{x}∥₁, which sums up all image amplitudes. The use of other norms below the 2 norm including combined norms are also conceivable.

In general, the method can be carried out with an object scene for which it can be assumed (even if the exact sparsity is not known) that at least two, preferably at least four, possibly at least six wave field sources (in particular radar sources, i.e. radar reflectors and/or active radar sources) and/or at most 200, preferably at most 100, still more preferably at most 50 wave field sources (in particular radar sources) are present. The term radar source is to be understood as an abbreviation for “radar reflector and/or active radar transmitter, for example radar transmitting antenna).

The shape and/or number and/or arrangement of the (respective) wave field sources/radar sources may or may not be known (for example in the case of a traffic situation present in a specific case from the point of view of a vehicle equipped with the measurement system or radar system).

In embodiments, the at least one parameter comprises at least one parameter relating to the calibration of a (respective) individual receiving unit. Alternatively or additionally, the at least one parameter may comprise a parameter relating to the calibration of an interaction (a cooperation) of several receiving units. The interaction (cooperation) may, for example, concern a communication and/or cooperative measurement of the receiving units with each other (i.e., for example, a transit time and/or form of signals that the receiving units exchange with each other).

At least one receiving unit preferably comprises at least one group of preferably coherently operating receivers (in particular receiving antennas), for example at least two or at least four coherently operating receivers. In this case, preferably at least one parameter of this at least one receiving unit is calibrated.

Alternatively or additionally, for several receiving units with (in each case) at least one receiver at least one parameter is calibrated.

In embodiments, the following is calibrated for at least one receiving unit (possibly several or all receiving units, if a plurality is present) and/or at least one receiver (possibly several or all receivers, if a plurality of receivers is present, wherein the receivers can be components of the same receiving unit or components of several different receiving units):
a phase position (in particular a phase offset with respect to at least one further receiving unit or one further receiver) and/or
an attenuation or gain (optionally absolute and/or relative to one further receiver/receiving unit, whereby this can correspond to a main diagonal in a coupling matrix, possibly in combination with the phase position) and/or
an orientation, for example with respect to a global reference orientation and/or with respect to at least one further receiving unit or one further receiver (or its orientation) and/or
a positioning, for example with respect to a global reference point and/or with respect to at least one further receiving unit or at least one further receiver (or its positioning) and/or
a coupling influence (for example described by a coupling matrix) due to a further receiving unit or a further receiver (in particular within the same receiving unit) and/or
a parameter describing a measurement relationship, in particular a coupling, between the receiving unit and a further receiving unit and/or
a parameter which describes a complex relative amplitude between the receiving unit and a further receiving unit, and/or
a parameter which describes a complex relative amplitude between the receiver and a further receiver, and/or
a parameter that describes a time offset to at least one further receiving unit or one further receiver.

In embodiments, different object scenes are used for calibration, with respect to which the (respective) receiving unit (in each case) assumes several positions. Again, the object scenes or their configuration need not be known in detail (except that they are, at least with some or predominant probability, different). For example, while a vehicle is moving, it can be assumed that object scenes considered at different times are different.

Preferably, the steps of the method for calibration (up to and including the formation of the set of multiple coherent measurement signals) are carried out at least twice (for at least two different object scenes), wherein the sets (of multiple coherent measurement signals) thus obtained are used for the calibration of the at least one parameter to be calibrated. It would also be conceivable to use the two sets (of several coherent measurement signals) together for the calibration of the parameter or to use them separately for this calibration, so that initially two separate calibrations take place, which are then in turn merged (for example by averaging a parameter set or determined by calibration).

The different object scenes may be, for example, different scenes detected by a vehicle (for example, while driving) or the corresponding wave-based measurement system (radar measurement system), or pre-known object scenes present, for example, within a stationary calibration arrangement, or either the one or both, in particular such that one of the several object scenes is a predetermined stationary object scene and a further object scene is present in a current use situation of the measurement system (for example, drive of a vehicle).

In general, the object scene may be (at least substantially) stationary in itself, so that in particular the individual objects or wave field sources do not move relative to each other (during the detection) or are assumed to be (at least substantially) stationary in themselves (or are such and behave during detection that a stationary object scene can be assumed).

In embodiments, the (respective) object scene may be moved with respect to a global reference point (in particular while the (respective) receiving unit is not moved with respect to these global reference points). In further alternative embodiments, the (respective) receiving unit may be moved with respect to a global reference point (in particular while the object scene is not moved with respect to this global reference point). In further alternative embodiments, both the (respective) object scene as well as the (respective) receiving unit may be moved with respect to to a global reference point. The global reference point shall preferably be considered as not moving and may be defined, for example, by a fixed point on a ground (or at least have an invariant position with respect to such a point on the ground).

In embodiments, at least one artificially created object scene may be used, for example comprising an arrangement of several separate structures (in particular bodies) which (actively) emit and/or reflect a signal, in particular metal bodies, for example (metal) spheres, preferably of known size and/or shape and/or position and/or surface properties and/or reflection properties.

Alternatively or additionally, the calibration can be performed online, for example when an object (in particular a vehicle, preferably motor vehicle) that is equipped with a corresponding calibration system or measurement system is in operation (for example drives).

Preferably, the calibration is performed (online) during a determination of properties of the object scene, for example during a method for reconstruction of an image of the object scene. In particular in this context, the object scene may be unknown at least in principle (also with respect to the arrangement of the objects or wave field sources), but preferably assumed to be stationary.

In embodiments, an at least rough pre-determination or pre-estimation of the parameter (to be calibrated) is carried out in a preceding step (possibly with a deviating method).

The parameter (to be calibrated) can be applied (for comparison or adjustment) to measurement data based on measurement signals.

Preferably, the calibration is performed with an object scene in the near field of a synthetic aperture formed by the measurement at the several positions and/or is performed in the near field of the combination of several receiving units and/or is performed in the near field of at least one receiving unit.

In embodiments, a position and/or angular position and/or a distance of objects of the object scene relative to the receiving unit is not (at least not exactly) known when performing the calibration and/or is not used for the calibration. However, this may be the case (see above).

In alternative embodiments, (only) parts of measurement data containing information about a part of an object scene are used.

In further alternative embodiments, (only) measurement data containing information on a (pre-)determined distance range are used.

Furthermore, additional constraints (to the above) may be applied to the calibration parameter in the method for calibration.

In particular, a signal power may be used to constrain the calibration parameter.

Specifically, the (respective) receiving unit may operate according to the FMCW radar principle and/or the OFDM radar principle.

The above-mentioned object is further solved by a calibration system for a wave-based measurement system, preferably radar measurement system, in particular vehicle radar system, preferably automotive radar system (truck and/or car radar system), preferably for carrying out the above method for calibration, wherein the calibration system is configured for calibration of at least one signal and/or system parameter of the measurement system, wherein a set of several coherent measurement signals is formed, which can be generated in that the at least one receiving unit and the object scene assume several spatial positions relative to each other, wherein a relative positioning of the several positions relative to each other is known or determined, and the signals are detected (in particular coherently) at these several positions by the at least one receiving unit, wherein a calibration of at least one signal and/or system parameter is carried out on based on the at least one set of coherent measurement signals.

The above-mentioned object is further solved by a wave-based measurement system, preferably radar measurement system, in particular vehicle radar system, preferably automotive radar system, preferably for carrying out the above method, comprising
at least one receiving unit for receiving signals of a wave field, in particular radar signals, emanating from a sparsely occupied object scene, as well as
the above calibration system.

The above object is further solved by an arrangement comprising an object scene as well as the above calibration system and/or the above measurement system.

The above object is further solved by a vehicle, in particular automobile (e.g. car or truck), motorbike, watercraft, aeroplane or helicopter, comprising the calibration system of the above type and/or the above measurement system and/or a calibration system configured to perform the above method for calibration.

Insofar as determinations, estimations and/or calculations are carried out to perform the above and/or subsequent method steps, at least one corresponding evaluation unit (as part of the calibration system or measurement system) may be provided for this purpose. This can be partially or completely part of a receiving unit (for example, in a common assembly, for example, arranged with it in a common housing) or (at least partially or completely) externally opposite to the receiving unit(s) (for example, in a separate housing). The (respective) receiving unit and/or the (respective) evaluation unit may have at least one (micro-)processor and/or at least one (electronic) memory and/or at least one input and/or output means for communication with further devices (e.g. via a wire connection or wirelessly).

Further embodiments result from the dependent claims.

### BRIEF DESCRIPTION OF THE DRAWINGS

In the following, the disclosure will also be described with reference to execution examples which will be explained in more detail with reference to the figures. Hereby show:

FIG. 1 a schematic representation of a calibration method according to the execution;

FIG. 2 a schematic representation for carrying out a method according to the execution; and

FIG. 3 a schematic representation of a system comprising an autonomous vehicle and a radar measurement system according to embodiments:

### DETAILED DESCRIPTION

In the following description, the same reference numerals are used for identical and identically acting parts.

In the following, a measurement arrangement with N_{M} measurement units (radar units or receiving units) is considered, which each have N_{Rx} receiving (RX) antennas, wherein the n_{Rx}-th antenna is located at the position \vec{p}_{Rx,n}_{_{Rx}}=(x_{Rx,n}_{_{Rx}}, y_{Rx,n}_{_{Rx}}, z_{Rx,n}_{_{Rx}}) relative to the radar centre.

In addition, preferably N_{Tx} transmit (TX) antennas are present, at the relative positions \vec{p}_{Tx,n}_{_{Tx}}=(x_{Tx,n}_{_{Tx}}, y_{Tx,n}_{_{Tx}}, z_{Tx,n}_{_{Tx}}).

For clarity, a single radar (or a single transmitting-receiving unit) is considered first. For data acquisition, its centre is located at the nₚ-th measurement position \vec{p}_{R,n}_{ₚ}=(x_{R,n}_{ₚ}, y_{R,n}_{ₚ}, z_{R,n}_{ₚ}), wherein 1≤nₚ≤Nₚ.

The data acquisition takes place in such a way that the TX antennas of the radar emit a signal s(t). This signal is scattered or reflected by an object scene and received by the RX antennas. Alternatively, it is also conceivable that a signal is emitted by an active object, e.g. by a radio transmitter (whereby in this case in particular no TX antenna needs to be present at the measurement unit or the receiving unit). In this case, however, it should be ensured that in the case of several measurements in succession there is a fixed phase relationship between the transmitted signals.

For a more compact representation, the following simplifications are assumed:
All reflecting objects are located within a spatial area that can be detected by the radar (or the receiving unit) at all positions Nₚ.
The directional behaviour of the antennas is uniform, constant and independent of direction.
A transmission channel is initially modelled as an ideal AWGN channel (AWGN=additive white Gaussian noise). I.e., the received signal results as a linear superposition of amplitude-weighted and time-delayed versions of the transmitted signal, which are overlaid by interferences n(t), which are assumed to be additive white Gaussian noise.

Under the assumption of N targets within the considered object scene at the a priori unknown positions \vec{p}_{K,n}_{_{K}}=(x_{K,n}_{_{K}}, y_{K,n}_{_{K}}, z_{K,n}_{_{K}}), an (ideal) received signal of a certain TX-RX combination (n_{Tx},n_{Rx}) at a position nₚ can be described as

sₙ_{ₚ}_{,n}_{_{Tx}}_{,n}_{_{Rx}}(t)=Σₙ_{_{K=1}}^{N}^{_{K}}αₙ_{ₚ}_{,n}_{_{Tx}}_{,n}_{_{Rx}}_{,n}_{_{K}}s(t−τₙ_{ₚ}_{,n}_{_{Tx}}_{,n}_{_{Rx}})+n(t),

Where αₙ_{ₚ}_{,n}_{_{Tx}}_{,n}_{_{Rx}}_{,n}_{_{K}} describes an attenuation resulting from the transmission path and Aₙ_{_{K}} describes the influence of the reflection at the target. Tₙ_{ₚ}_{,n}_{_{Tx}},ₙ_{_{Rx}},ₙ_{_{K}} indicates the signal propagation time from TX via the target to RX and is calculated as

$${τ}_{{n}_{p} , {n}_{Tx} , {n}_{Rx} , {n}_{K}} = \frac{{r}_{{n}_{p} , {n}_{Tx} , {n}_{Rx} , {n}_{K}}}{c} ,$$

with the propagation speed c of the wave and the distance

rₙ_{ₚ}_{,n}_{_{Tx}}_{,n}_{_{Rx}}_{,n}_{_{K}}=∥\vec{p}_{K,n}_{_{K}}+\vec{p}_{Tx,n}_{_{Tx}})∥₂+∥(\vec{p}_{R,n}_{ₚ}+\vec{p}_{Rx,n}_{_{Rx}})−\vec{p}_{K,n}_{_{K}}∥₂.

Transforming the received signal into the frequency range results in:

$${S}_{{n}_{p} , {n}_{Tx} , {n}_{Rx}} ( ω ) = {\sum }_{{n}_{K} = 1}^{{N}_{K}} {α}_{{n}_{p} , {n}_{Tx} , {n}_{Rx} , {n}_{K}} {A}_{{n}_{K}} S ( ω ) {e}^{- j ω {r}_{{n}_{p} , {n}_{Tx} , {n}_{Rx} , {n}_{K}}} + N ( ω ) .$$

In imaging systems, the target distribution \vec{x} can be determined, which contains the complex amplitudes Aₙ_{_{K}} at certain spatial points \vec{p}_{K,n}_{_{K}}. The data acquisition at a measurement point nₚ can now be regarded as a linear operator Hₙ_{ₚ}, which maps the target distribution to the measurement values, which can be collected in a vector, \vec{y}ₙ_{ₚ} so that holds

\vec{y}ₙ_{ₚ}=Hₙ_{ₚ}\vec{x}+\vec{n}ₙ_{ₚ}.

Due to the limited aperture of classical receiving units (radar sensors), the resolution of the imaging is usually insufficient for single measurements. In particular, the different measurement accuracy in distance and angular resolution can prevent a reliable reconstruction. Therefore—as already indicated by the index nₚ—several measurements at different positions are coherently processed with each other and thus an aperture is spanned. In radar imaging this is also called synthetic aperture. For that, the relative measurement positions of the radar system must be known (comparatively accurately) in order to enable a coherent evaluation.

The procedure proposed here for the calibration, on the other hand, places significantly lower demands on a reference system or traversing system than an (exact) determination of the relative positions of a target in relation to the measurement system (or the receiving unit).

If the data recording occurs as described at several positions nₚ=1 . . . Nₚ, the total system of equations results in

\vec{y}=H\vec{x}+\vec{n},

wherein the total measurement vector) \vec{y}, as well as the total measurement matrix H can be easily composed of the individual measurements

$$\vec{y} = ( \begin{matrix}{\vec{y}}_{1} \\ ⋮ \\ {\vec{y}}_{{N}_{p}}\end{matrix} ) , H = ( \begin{matrix}{H}_{1} \\ ⋮ \\ {H}_{{N}_{p}}\end{matrix} ) .$$

Since the total system of equations is (usually) severely underdetermined even with measurements at several positions, typically the target distribution \vec{x} sought cannot be determined from the measurement by simple matrix inversion.

Classical approaches to image reconstruction can be based on correlation, such as with the matched-filter approach, in which it is multiplied with a complex conjugate signal. In this case, the estimated image \vec{b} is given by \vec{b}=H^{H}\vec{y}, wherein the operator (⋅)^{H} describes the transposed-conjugate matrix. This corresponds (in principle) to a comparison of the actual measurement with a hypothetical measurement signal that would be produced with a target at the position \vec{p}_{K,n}_{_{K}}. Here, also, the underdetermination can prevent a correct reconstruction of the target distribution \vec{x}.

In recent years, another reconstruction approach has also been researched, which is based on the principles of so-called compressed sensing. Here it is assumed that the target distribution consists of only a few individual targets, i.e. the scene is sparsely occupied (“sparse”). Accordingly, the vector \vec{x} has only a few entries that are unequal to zero. Thus, it is sought the solution \vec{x} for the system of equations, which minimises the error power ∥\vec{y}−H\vec{x}∥₂ and additionally is a solution as sparse as possible.

As described above, sparse solutions are typically achieved by minimising the l0 norm ∥\vec{x}μ₀ of the target vector, which determines the number of pixels that are unequal to zero, or by minimising the l1 norm ∥\vec{x}μ₁, which sums up all image amplitudes. The use of other norms below the 2 norm including combined norms are also conceivable. This corresponds to an optimisation with several target functions, which can be formulated as

$${min}_{\vec{x}} {‖ \vec{x} ‖}_{1} subject to {‖ \vec{y} - H \vec{x} ‖}_{2} \leq ε ,$$

wherein ϵ is used as limiting factor for the error power, and can be estimated from the received noise power of the sensors. At low noise, this works via the condition ∥\vec{y}−H\vec{x}∥₂=0. Other formulations of this optimisation are also conceivable, such as

$${min}_{\vec{x}} {‖ \vec{y} - H \vec{x} ‖}_{2} subject to {‖ \vec{x} ‖}_{1} \leq β ,$$

$${min}_{\vec{x}} {‖ \vec{y} - H \vec{x} ‖}_{2} + λ {‖ \vec{x} ‖}_{1} ,$$

$${min}_{\vec{x}} {‖ \vec{x} ‖}_{1} + λ {‖ \vec{y} - H \vec{x} ‖}_{2} ,$$

$${min}_{\vec{x}} {‖ \vec{x} ‖}_{0} subject to {‖ \vec{y} - H \vec{x} ‖}_{2} \leq ε ,$$

$${min}_{\vec{x}} {‖ \vec{y} - H \vec{x} ‖}_{2} subject to {‖ \vec{x} ‖}_{0} \leq β ,$$

$${min}_{\vec{x}} {‖ \vec{y} - H \vec{x} ‖}_{2} + λ {‖ \vec{x} ‖}_{0} ,$$

$${min}_{\vec{x}} {‖ \vec{x} ‖}_{0} + λ {‖ \vec{y} - H \vec{x} ‖}_{2} ,$$

Wherein β is the maximum cumulative image amplitude that can be estimated given a known number and type of targets, and A is a weighting factor for the two sub-targets of the optimisation.

Given sufficient prior information, such as the (approximate) positions and number of targets, it is also possible to estimate the target positions \vec{p}_{K,n}_{_{K}} directly, rather than amplitudes at hypothetical positions. This would change the optimisation to

$${min}_{\vec{{p}_{K}} , 1 , … , \vec{{p}_{K}} , {N}_{K}} \vec{y} - {H ( \vec{{p}_{K}} , 1 , … , \vec{{p}_{K}} , {N}_{K} )}_{2} \leq ε$$

or comparable forms.

In this case, the l1 norm can be omitted, since when estimating target positions directly, the number of targets is implicitly given. In this respect, this can be understood as error minimisation.

For real measurement units, the measurement matrix H may deviate from the ideal measurement matrix H_{ideal} and depend on parameters that are not fully known. For radar sensors (receiving units) with several RX antennas (receivers), this is/are, for example, an unknown gain and/or phase shift per channel, and/or coupling effects between the individual antennas. These are usually combined in a coupling matrix C so that H=CH_{ideal}. But also other parameters \vec{γ}—such as a tilt of the respective receiving unit and/or the respective receiver—can have an influence on the measurement matrix.

Generally, there is an unknown parameter set c to be calibrated which influences the measurement matrix. The measurement equation then changes to:

A known technique for calibrating the coupling matrix is based on reference measurements to targets (e.g. triple mirrors) at known angles, as described above.

Based on compressed sensing (as also described in principle above), there are also approaches for the simultaneous calibration of different parameters and angle estimation or estimation of a sparse scene. By that no known angles or target positions need to be given. For that, the approach for imaging with compressed sensing is supplemented by a further variable to be estimated, and it follows for example

$${min}_{\vec{x} , \vec{α}} {‖ \vec{x} ‖}_{1} subject to {‖ {\vec{y}}_{{n}_{p}} - {H}_{{n}_{p}} ( \vec{α} ) \vec{x} ‖}_{2} \leq ε .$$

Other forms of formulation corresponding to the forms introduced above are also possible.

However, so far this is only proposed as a so-called online calibration, which makes it possible to perform an angle estimation in a measurement situation even with an uncalibrated system. Only one measurement each is used to estimate the calibration parameters, which is why in the above online calibration equation the measurement vector and the measurement matrix were reduced again to the measurement vector ∥\vec{y}ₙ_{ₚ} and the measurement matrix Hₙ_{ₚ} at a single position \vec{p}ₙ_{ₚ}. Thus, as described before, little information is available.

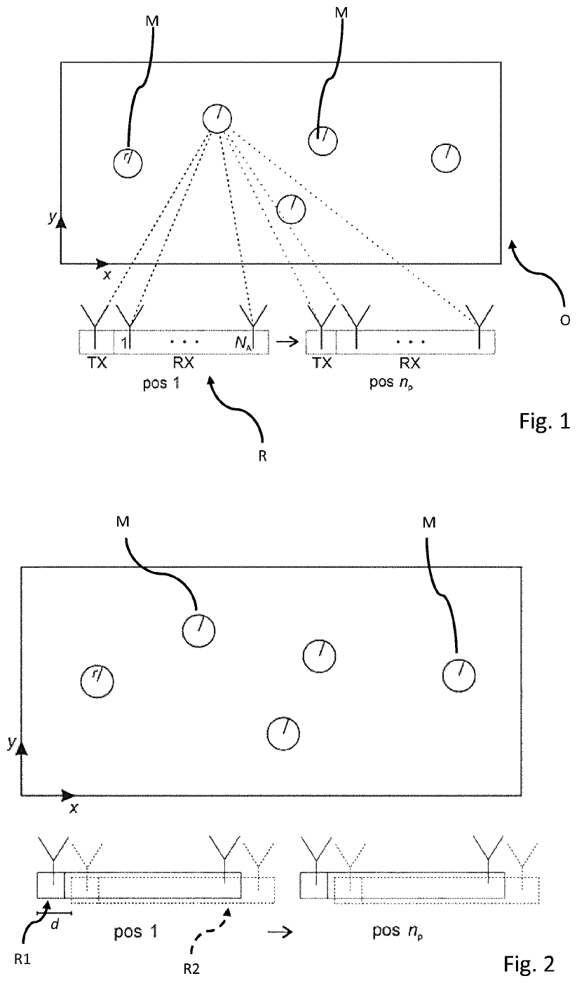

Preferably, it is now proposed in particular to extend the idea of (online) calibration based on compressed sensing by taking and (coherently) processing several measurements for a sparsely occupied scene at different positions pos 1, . . . , pos nₚ (see FIG. 1), i.e. building up a synthetic aperture.

In this way, a measurement data vector as well as a measurement matrix can be (significantly) enlarged compared to a single measurement and an information content can be (significantly) increased. A measurement matrix is now, in addition to a (respective) calibration parameter, also dependent on measurement positions (H(\vec{p}_{R,n}_{ₚ},\vec{α}), wherein these are assumed as known, however.

The basic set-up is shown in FIG. 1. The radar is located here exemplarily at Nₚ different radar positions and measures to a sparsely occupied arrangement, which is shown here as an arrangement of metal spheres, but can be shaped by any targets.

The positions of the targets can be unknown and co-estimated in the context of the calibration. Only their relative position to each other must remain (at least essentially) constant during the measurement, so it should be a fixed scene. Information about a relative movement of the radar or the receiving unit R and/or the entire object scene O, is (significantly) easier to determine than the total absolute positions of the radar R and all targets M. Thus, the radar R can be moved in the case of a static scene, the scene in the case of a static radar, or both relative to each other.

As long as this relative movement is known, it can be assumed without restriction for a simpler description in the following that there is a radar movement with a static scene, which is described by the measurement positions ∥\vec{p}_{R,n}_{ₚ} relative to any point.

With these measured values, it is then possible with

$${min}_{\vec{x} , \vec{α}} {‖ \vec{x} ‖}_{1} subject to {‖ \vec{y} - H ( \vec{α} ) \vec{x} ‖}_{2} \leq ε ,$$

or a comparable approach (see above), to determine any calibration parameters \vec{α}. If necessary, additional restrictions can be made, for example to prevent that e.g. a trivial solution occurs, or that one of the searched parameters is chosen in such a way that one of the (two) optimisation targets is no longer a restriction of the solution space.

The reconstruction image \vec{x} determined at the same time is (only) a means for calibration and does not necessarily have to be determined correctly. If only one single measurement is taken for the minimisation, as in the online calibration explained above, dependencies between the parameter set \vec{α} and the image reconstruction I now arise, which strongly limit the parameters that can be calibrated.

For example, when measuring at a position with targets (at unknown positions) in the far field, no calibration of the distance between two arrays that are not coherent to each other is possible because a reference value for the distance is missing. Also, too many parameters have to be determined for the estimation of a coupling matrix. Even if a calibration with a measurement were theoretically possible, it will not work in practice because it is influenced by further measurement errors such as noise or erroneous antenna directional characteristics.

Also here, it is possible, as described above, to estimate the positions \vec{p}_{K,1}, . . . , \vec{p}_{K,N}_{_{K}} of the targets directly if the pre-estimation is sufficiently good. This would be advantageous, for example, after a good pre-estimation of the parameter set \vec{α} and the image reconstruction \vec{x} has already been made based on the method according to execution.

The advantage of the method according to execution compared to the online calibration with compressed sensing explained above is in particular that by the generation of a larger aperture due to the relative movement of sensor and object scene, significantly more information is collected than would be available with a single measurement. In addition, this information is available coherently, unlike as with conventional calibration methods, whereby the full information can be used and a high sensitivity is achieved.

Thus, the object scene can now possibly already be determined from the coherent shift before the calibration parameters are determined. If, for example, a fixed transmitter emits onto a fixed scene, whereby a receiver with several antennas is shifted, a single antenna is already sufficient for the imaging of the scene, whereby a complete calibration of all relative parameters (automatically) is enabled.

In this way, for example, a coupling matrix can also be unambiguously determined, and in particular no unknown rotation factor remains as with some approaches to compressed sensing online calibration.

Furthermore, this enables in particular a calibration in the near field of the sensor or the aperture, which is spanned by the relative movement. Multipath propagation can then be (simply) reduced, for example, by placing the target arrangement close to the sensor and so far away from strong multipath-generating reflectors (e.g. the ground) that multipaths lead to significantly longer signal paths than the direct link.

In this case, these can be easily separated from the direct paths in a received signal. Then, for example, only the measured values associated with targets at short distances can be used for calibration, and those belonging to long distances and thus multipaths can be omitted. In particular, there is no longer a need for a reflection-free measurement chamber. Any remaining multipaths change with the varying radar position (receiving unit position) and thereby become more and more a random quantity, which can be attributed to the noise, with increasing synthetic aperture.

Under controlled calibration conditions (offline calibration), it can be advantageous to select the target scene in such a way that the reflection behaviour of the targets is described or known (as well as possible) and the measurement matrix H represents a (at least as far as possible) correct description of the measurement. In radar applications, for example, infinitely small point targets that scatter uniformly in all directions can be assumed standardly.

If known scattering bodies, such as metal spheres and/or metal rods, possibly with known shape and/or size (e.g. radius r) are selected, their reflection behaviour is preferably integrated into the matrix H. Possible unwanted scattering bodies in the scene then show a correspondingly different reflection behaviour than is expected in the measurement equation and can be regarded as noise (especially at comparatively large synthetic apertures).

Furthermore, it is advantageous to include information known in advance (such as the number of targets) in the calibration in the case of a selective setup.

As an execution example of a calibration with a selective setup, a calibration of a coupling matrix C in a (radar) receiving unit can be considered. The (radar) receiving unit may be an FMCW receiving unit with a transmitting antenna and N_{Rx}=8 receiving antennas (or another number of receiving antennas), which may be arranged as a linear array (cf. FIG. 1). The radar can be positioned on a traversing stand which allows precise relative movements along the axis in which also the antennas are arranged. An arrangement of N_{K}=6 metal spheres (with identical and known radius r) is placed in front of the receiving unit R. Other (metal) bodies are possible in a different number.

All metal spheres are optionally located (at least approximately) in the same plane as the antennas, so that possibly a 2D evaluation may be sufficient (at least if a linear array is present). Alternatively or additionally, a 3D evaluation can also be performed.

The receiving unit R can now be moved past the metal spheres M and record measurement data at several positions.

In this case, the number of targets searched for is known, as well as additionally an estimate of the backscatter cross-section per sphere and thus of Aₙ_{_{K}}=A_{Kugel} possible.

Thus, for simultaneous minimisation of the error power and of the total image amplitude, an optimisation of the form

$${min}_{\vec{x} , C} {‖ \vec{y} - {CH}_{ideal} \vec{x} ‖}_{2} subject to {‖ \vec{x} ‖}_{1} \leq {N}_{K} {A}_{Kugel}$$

presents itself, in which the total image amplitude is limited to the expected amplitude. In this case, the calibration parameter is separable from the measurement matrix. This leads to the fact that \vec{x} and C can only be solved to an arbitrary factor v, since for each solution \vec{α} and C there exists an equivalent solution

$$\frac{1}{v} \vec{x}$$

and vC for the error power. Thus,

$${‖ \frac{1}{v} \vec{x} ‖}_{1}$$

can become (amitrarily) small and the conaition that

$${‖ \frac{1}{v} \vec{x} ‖}_{1}$$

should be smaller than N_{K}A_{Kugel} no longer represents a restriction on the solution space.

Therefore, an additional constraint for \vec{x} or C can be introduced, such as that C must not fall below a certain power on the main diagonal. For the solution of the resulting non-convex optimisation, an iterative approach can be chosen in which per iteration \vec{x} and C are estimated in alternation. Then, for example, C is normalised in such a way that its first entry C(1,1) results in 1 in terms of amount. In this way, the influence of the ambiguities or trivial solution described above can be reversed.

Furthermore, in case of not exactly known sphere amplitude A_{Kugel}, it can be corrected by scaling the coupling matrix or directly by A_{Kugel} in that it is taken into account that the power of the measurement signal E_{y} and the power of the hypothetical measurement signal E_{Hx} must be identical.

In each iteration i, thus according to the execution two convex optimisations are thus carried out, each for one variable, then normalised and/or, if necessary, the amplitude is adjusted, preferably as follows:
1. estimate \vec{x}ᵢ with a pre-estimate of Cᵢ₋₁:

$${min}_{{\vec{x}}_{i}} {‖ \vec{y} - {C}_{i - 1} {H}_{ideal} {\vec{x}}_{i} ‖}_{2} subject to {‖ {\vec{x}}_{i} ‖}_{1} \leq {N}_{K} {A}_{Kugel}$$

2. estimate c′ᵢ with pre-estimate of \vec{x}ᵢ:

$${min}_{{C}_{i}} {‖ \vec{y} - {C}_{i}^{′} {H}_{ideal} {\vec{x}}_{i} ‖}_{2}$$

3. normalise c′ᵢ: cᵢ=c′ᵢ/|c′ᵢ(1,1)|
4. adjust A_{Kugel}.

Due to the separability of the calibration parameter from the measurement matrix, it is just as well possible here to estimate a correction matrix M=C⁻¹ instead of the actual coupling. Thus the measurement equation can be rewritten as ∥M\vec{y}−H_{ideal}\vec{x}μ₂. This is equivalent to the problem described before. In this formulation, however, a minimum of the error power is reached when both M as well as \vec{x} tend towards zero. This trivial solution can therefore also be prevented by additional constraints.

So far, for simplification, it has been assumed that the arrangement consists of a single radar or a single receiving unit (N_{M}=1) within which data can be (coherently) processed. For further applications, however, several measurement units can also be evaluated in parallel. In this case, parameters can be relevant which describe how the measurement relationship between these receiving units (measurement units) is, e.g. how the position of one receiving unit is relative to another receiving unit.

As long as all measurement units observe the same (sparse) object scene, this can be traced back to an identical problem as it was described above for a single receiving unit (measurement unit) by combining the measurement data \vec{y}ₙ_{_{M}} (1≤n_{M}≤N_{M}) and the measurement matrix Hₙ_{_{M}} of the individual sensors into an total vector or total matrix, so that e.g.

$${min}_{\vec{x} , \vec{α}} {‖ \vec{x} ‖}_{1} subject to {‖ ( \begin{matrix}{\vec{y}}_{1} \\ ⋮ \\ {\vec{y}}_{{N}_{M}}\end{matrix} ) - ( \begin{matrix}{H}_{1} ( \vec{α} ) \\ ⋮ \\ {H}_{{N}_{M}} ( \vec{α} )\end{matrix} ) \vec{x} ‖}_{2} \leq ε$$

results as an optimisation function.

In order to coherently process two spatially separated receiving units (radar sensors) R1 and R2 (see FIG. 2, where R2 is drawn dashed) e.g. in the automotive sector, among other things, a distance d (in particular significantly smaller than the wavelength) of the receiving units is required. For calibration, the receiving units R1, R2 (radars) are moved past a sparse scene (as according to FIG. 1) and record measurement data at several positions pos 1, . . . , pos nₚ. The same setup as in FIG. 1 can be used for this, except that both receiving units (radars) are moved as a rigid arrangement on a traversing stand. The optimisation problem could then be formulated as e.g.

$${min}_{\vec{x} , d} {‖ ( \begin{matrix}{\vec{y}}_{1} \\ {\vec{y}}_{2}\end{matrix} ) - ( \begin{matrix}{H}_{1} \\ {H}_{2} ( d )\end{matrix} ) \vec{x} ‖}_{2} subject to {‖ \vec{x} ‖}_{1} \leq {N}_{K} {A}_{Kugel} ,$$

wherein only the partial measurement matrix of R2 is dependent on the distance d to be calibrated if R1 is chosen as the reference point. This is again possible no absolute target and sensor positions need to be known (but only the relative movement of total sensor and target distribution is relevant).

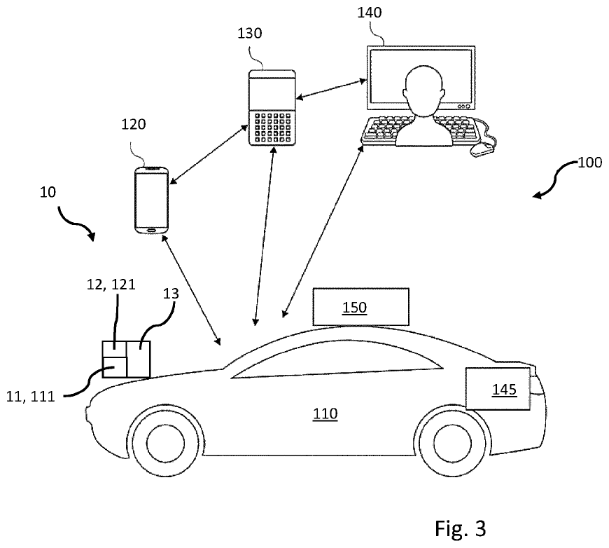

FIG. 3 shows a system 100 comprising an autonomous vehicle 110 and a radar measurement system 10 according to embodiments. The radar measurement system 10 comprises a first radar unit 11 with at least one first radar antenna 111 (to transmit and/or receive corresponding radar signals), a second radar unit 12 with at least one second radar antenna 121 (to transmit and/or receive corresponding radar signals), as well as a calibration calculation unit 13.

The system 100 may comprise a passenger input and/or output device 120 (passenger interface), a vehicle coordinator 130 and/or an external input and/or output device 140 (remote expert interface; for example for a control centre). In embodiments, the external input and/or output device 140 may allow a person and/or device external (to the vehicle) to make and/or modify settings on or in the autonomous vehicle 110. This external person/device may be different from the vehicle coordinator 130. The vehicle coordinator 130 may be a server.

The system 100 enables the autonomous vehicle 110 to have a driving behaviour dependent on parameters which to modify and/or set by a vehicle passenger (for example, using the passenger input device and/or output device 120) and/or other persons and/or devices involved (for example, via the vehicle coordinator 130 and/or the external input and/or output device 140). The driving behaviour of an autonomous vehicle may be predetermined or modified by (explicit) input or feedback (for example by a passenger that specifies a maximum speed or a relative comfort level), by implicit input or feedback (for example a pulse of a passenger), and/or by other suitable data and/or communication methods for a driving behaviour or preferences.

The autonomous vehicle 110 is preferably a fully autonomous motor vehicle (e.g. car and/or truck), but may alternatively or additionally be a semi-autonomous or (other) fully autonomous vehicle, for example a watercraft (boat and/or ship), a (particularly unmanned) aircraft (plane and/or helicopter), a driverless motor vehicle (e.g. car and/or truck) et cetera. Additionally or alternatively, the autonomous vehicle may be configured such that it can switch between a semi-autonomous state and a fully-autonomous state, wherein the autonomous vehicle may have properties that may be associated with both a semi-autonomous vehicle as well as a fully-autonomous vehicle (depending on the state of the vehicle).

Preferably, the autonomous vehicle 110 comprises an on-board computer 145.

The calibration calculation unit 13 may be at least partially arranged in and/or on the vehicle 110, in particular (at least partially) integrated into the on-board computer 145, and/or (at least partially) integrated into a calculation unit in addition to the on-board computer 145. Alternatively or additionally, the calibration calculation unit 13 may be (at least partially) integrated in the first and/or second radar unit 11, 12. If the calibration calculation unit 13 is (at least partially) provided in addition to the on-board computer 145, the calibration calculation unit 13 may be in communication with the on-board computer 145 so that data may be transmitted from the calibration calculation unit 13 to the on-board computer 145 and/or vice versa.

Additionally or alternatively, the calibration calculation unit 13 may be (at least partially) integrated with the passenger input device and/or output device 120, the vehicle coordinator 130, and/or the external input and/or output device 140. In particular, in such a case, the radar measurement system may comprise a passenger input device and/or output device 120, a vehicle coordinator 130, and/or an external input and/or output device 140.

In addition to the at least one radar unit 11, 12, the autonomous vehicle 110 may comprise at least one further sensor device 150, (for example, at least one computer vision system, at least one LIDAR, at least one speed sensor, at least one GPS, at least one camera, etc.).

The on-board computer 145 may be configured to control the autonomous vehicle 110. The on-board computer 145 may further process data from the at least one sensor device 150 and/or at least one other sensor, in particular a sensor provided or formed by at least one radar unit 11, 12, and/or data from the calibration calculation unit 13 to determine the status of the autonomous vehicle 110.

Based on the status of the vehicle and/or programmed instructions, the on-board computer 145 can preferably modify or control the driving behaviour of the autonomous vehicle 110. The calibration calculation unit 13 and/or the on-board computer 145 is (are) preferably a (general) calculation unit adapted for I/O communication with a vehicle control system and at least one sensor system, but may additionally or alternatively be formed by any suitable calculation unit (computer). The on-board computer 145 and/or the calibration calculation unit 13 may be connected to the internet via wireless connection. Alternatively or additionally, the on-board computer 145 and/or the calibration calculation unit 13 may be connected to any number of wireless or wired communication systems.

For example, any number of electrical circuits, in particular as part of the calibration calculation unit 13 and/or the on-board computer 145, the passenger input device and/or output device 120, the vehicle coordinator 130 and/or the external input and/or output device 140 may be implemented on a circuit board of a corresponding electronic device. The circuit board may be a general circuit board (“circuit board”) that may have various components of an (internal) electronic system, an electronic device and connections for other (peripheral) devices. Specifically, the circuit board may have electrical connections through which other components of the system may communicate electrically (electronically). Any suitable processors (for example, digital signal processors, microprocessors, supporting chipsets, computer-readable (non-volatile) memory elements, etc.) may be coupled to the circuit board (depending on corresponding processing requirements, computer designs, etc.). Other components, such as an external memory, additional sensors, controllers for audio-video playback, and peripheral devices may be connected to the circuit board, such as for example as plug-in cards, via cables, or integrated into the circuit board itself.

In various embodiments, functionalities described herein may be implemented in emulated form (as software or firmware), with one or more configurable (for example, programmable) elements which are arranged in a structure that enables that function. The software or firmware providing the emulation may be provided on a (non-volatile) computer-readable storage medium comprising instructions that allow one or more processors to perform the corresponding function (the corresponding process).

The above description of the embodiments shown does not purport to be exhaustive or limited as to the exact embodiments as described. While specific implementations of and examples of various embodiments or concepts have been described herein for illustrative purposes, deviating (equivalent) modifications are possible as is apparent to those skilled in the art. These modifications may be made taking into account the detailed description above or the figures.

Various embodiments may include any suitable combination of the embodiments described above, including alternative embodiments of embodiments described above in conjunctive form (e.g., the corresponding “and” may be an “and/or”).

In addition, some embodiments may comprise one or more objects (e.g., in particular, non-volatile computer-readable media) with instructions stored thereon that, when executed, result in an action (a process) according to one of the embodiments described above. In addition, some embodiments may comprise devices or systems having any suitable means for performing the various operations of the embodiments described above.

In certain contexts, the embodiments discussed herein may be applicable to automotive systems, in particular autonomous vehicles (preferably autonomous automobiles), (safety critical) industrial applications and/or industrial process controls.

Furthermore, parts of the described calibration system and/or the described radar measurement system (or in general: wave-based measurement system) may comprise electronic circuits to perform the functions as well as methods described herein. In some cases, one or more parts of the respective system may be provided by a processor that is specifically configured to perform the functions as well as method steps described herein. For example, the processor may include one or more application-specific components, or it may include programmable logic gates which are configured in such a way that they perform the functions described herein.

At this point, it should be pointed out that all of the parts described above individually and in any combination, in particular the details shown in the drawings, are claimed as essential to the disclosure. Modifications thereof are familiar to those skilled in the art.

Furthermore, it is pointed out that a scope of protection as broad as possible is sought. In this respect, the disclosure contained in the claims can also be made more precise by features which are described with further features (even without that these further features are to be included necessarily). It is explicitly pointed out that round brackets and the term “in particular” in their respective contexts are not intended to emphasise the optionality of features (which is not intended to mean, conversely, that without such identification a feature is to be regarded as mandatory in the corresponding context).

### REFERENCE SIGNS

R, R1, R2 receiving unit (radar unit);

M metal sphere;

10 radar measurement system;

11 first receiving unit (radar unit);

111 first radar antenna;

12 second receiving unit (radar unit);

121 second radar antenna;

13 calibration calculation unit

100 system

110 vehicle

120 passenger interface

130 vehicle coordinator

140 remote expert interface

145 on-board computer

50 sensor device

1. A method for radar measurement, using at least one receiving unit for receiving radar signals, which emanate from a sparsely occupied object scene, the method comprising:
coherently detecting radar signals at respective positions assumed by the at least one receiving unit and the object scene relative to each other, where a relative positioning of the respective positions with respect to each other is known or determined, to form a set of coherent measurement signals; and
calibrating at least one signal or system parameter based on the at least one set of coherent measurement signals.

2. The method of claim 1, wherein the at least one receiving unit comprises at least one receiver and comprises at least one transmitter.

3. The method of claim 1, comprising:
comparing the set of coherent measurement signals or signals derived from the set of coherent measurement signals with hypothetical comparison signals dependent on at least one parameter to be calibrated and adependent on a hypothetical target distribution, where the hypothetical target distribution is sparsely occupied.

4. The method of claim 1, wherein the at least one parameter comprises at least one parameter which relates to the calibration of a single receiving unit or comprises a parameter which relates to the calibration of an interaction of respective receiving units.

5. The method of claim 1, preceding claims, at least one group of coherently operating receivers is calibrated or at least one parameter is calibrated for respective receiving units each having at least one receiver.

6. The method of claim 1, wherein comprising calibrating at least one of:
a phase offset of the at least one receiving unit or the at least one receiver, with respect to at least one further receiving unit or at least one further receiver;
an attenuation or gain of at the least one receiving unit or at least one receiver with respect to at least one further receiving unit or at least one further receiver;
an orientation of at the least one receiving unit or at least one receiver, with respect to a global reference orientation or with respect to at least one further receiving unit or at least one further receiver;
a positioning of at the least one receiving unit or at least one receiver, with respect to a global reference point or with respect to at least one further receiving unit or at least one further receiver;
a coupling influence on the at least one receiving unit or at least one receiver due to a further receiving unit or a further receiver;
a parameter which describes a measurement relationship, in particular a coupling, between the at least one receiving unit or at least one receiver and a further receiving unit;
a parameter which describes a complex relative amplitude between the at least one receiving unit or at least one receiver and a further receiving unit or
a parameter which describes a time offset to at least one further receiving unit or at least one further receiver.

7. The method of claim 1, wherein different object scenes are used for the calibration.

8. The method of claim 1, wherein the object scene is stationary.

9. The method of claim 1, wherein for assuming the respective positions the object scene is moved relative to a global reference point or the at least one receiving unit is moved relative to a global reference point or both the object scene and the receiving unit are moved relative to a global reference point.

10. The method of claim 1, wherein at least one artificially created object scene is used, comprising an arrangement of signal emitting or reflecting bodies having known properties.

11. The method of claim 1, wherein the calibration is performed in relation to reconstruction of an image of the object scene.

12. The method of claim 1, comprising performing a rough pre-determination or pre-estimation of the at least one signal or system parameter.

13. The method of claim 1, wherein a calibrated representation of the at least one signal or system parameter is applied to measurement data which are based on measurement signals.

14. The method of claim 1, wherein the calibration is performed with an object scene in a near field of at least one receiving unit or a combination of receiving units.

15. The method of claim 1, wherein a position or angular position or a distance of objects of the object scene relative to the receiving unit upon performing the calibration is not known or is not used for the calibration.

16. A system for performing calibration of a radar measurement system, the calibration system configured for:
coherently detecting radar signals at respective positions assumed by at least one receiving unit for receiving which emanate from a sparsely occupied object scene, the at least one receiving unit and the object scene assuming the respective positions relative to each other, where a relative positioning of the respective positions with respect to each other is known or determined, to form a set of coherent measurement signals; and
calibrating at least one signal or system parameter based on the at least one set of coherent measurement signals.

17. The system of claim 16, comprising the at least one receiving unit.

18. The system of claim 17, wherein the at least one receiving unit is located on or included as a portion of a vehicle.

19. The system of claim 18, wherein the vehicle comprises a motor vehicle.
